(19) United States
(12) Patent Application Publication
(10) Pub. No.: US 2013/0121544 A1
(43) Pub. Date: May 16, 2013

(54) METHOD, SYSTEM, AND APPARATUS FOR PRESSURE IMAGE REGISTRATION

(71) Applicant: The Regents of the University of California, Oakland, CA (US)

(72) Inventors: Majid Sarrafzadeh, Anaheim Hills, CA (US); William Kaiser, Los Angeles, CA (US); Ani Nahapetian, Glendale, CA (US); Alireza Vahdatpour, Los Angeles, CA (US); Mahsan Rofouei, Los Angeles, CA (US)

(73) Assignee: THE REGENTS OF THE UNIVERSITY OF CALIFORNIA, Oakland, CA (US)

(21) Appl. No.: 13/667,912

(22) Filed: Nov. 2, 2012

Related U.S. Application Data
(63) Continuation of application No. PCT/US2011/035622, filed on May 6, 2011.
(60) Provisional application No. 61/332,752, filed on May 8, 2010.

(51) Int. Cl. G06T 7/00

(52) U.S. Cl. CPC G06T 7/0012
USPC 382/128

(57) ABSTRACT

An image registration system and methods that enables mapping of a surface's image scan, such as wound image scans, to each other for comparison and study, due to the variations in the image captures. Correspondence between two images is established and an optimal transformation between two images is determined. The two images (source and target) are either from the same scene acquired at different times or from different views.

### CROSS-REFERENCE TO RELATED APPLICATIONS

This application is a 35 U.S.C. §111(a) continuation of PCT international application number PCT/US2011/035622 filed on May 6, 2011, incorporated herein by reference in its entirety, which is a nonprovisional of U.S. provisional patent application Ser. No. 61/332,752 filed on May 8, 2010, incorporated herein by reference in its entirety. Priority is claimed to each of the foregoing applications

The above-referenced PCT international application was published as PCT International Publication No. WO 2011/143073 on Nov. 17, 2011 and republished on Dec. 29, 2011, and is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to image registration, and more particularly to pressure image registration for wound care.

2. Description of Related Art

In medical sensing devices, readings are captured using various sensors. In order to monitor the progress of a certain condition, additional readings are taken after specific time and are aligned to determine changes. However this task is often difficult to perform. Images captured from different readings, from different days, are difficult, if not impossible to properly align at the time of the sensor application using presently available techniques. Pressure image registration enables mapping of sensor readings to each other for comparison and study, due to the variations in the image captured. The goal of registration is to establish the correspondence between two images and determine an optimal transformation between two images. The two images (source and target) may be either from the same scene acquired at different times or from different view points.

Currently, wound scans are obtained in several rudimentary ways. Visual observation, which is the most common way to monitor a wound, is prone to error, subjectivity of the observer, and finally is dependent on skin color.

Image registration has applications in remote sensing, computer vision, medical imaging, weather forecasting, etc. Various registration techniques have been used. FIG. 1 illustrates a high-level flow diagram of a prior art registration method 10.

In most registration techniques, the first step is to perform feature detection. Features can be edges, contours, corners, regions, etc. The point representatives of these features are called Control Points (CPs). These features are captured in both source and target images. Examples of region features can be buildings, forests, lakes etc. Examples of point regions which are more of particular interest are the most distinctive points with respect to a specified measure of similarity, local extrema of wavelet transform, etc. Feature detection can be both performed manually or automatically.

In the next step at block 14, the correspondence between these features in both images is obtained. In feature-based registration, methods using spatial relations invariant descriptors, relaxation methods and pyramids and wavelets may be used. With this information, the transform model may then be estimated at block 16. This stage estimates the parameters of a mapping function, which aligns the two images. Finally the mapping function is then used to transform the target image at block 18.

### BRIEF SUMMARY OF THE INVENTION

Wound image registration according to an aspect of the invention enables mapping of wound image scans to each other for comparison and study, due to the variations in the image capture. The goal of registration is to establish the correspondence between two images and determine an optimal transformation between two images. The two images (source and target) are either from the same scene acquired at different times or from different view points.

The invention standardizes wound management images, which is important for analysis and inference of the data obtained from wound management and monitoring systems.

In one aspect of the present invention, pressure information is captured in addition to desired sensor data. This creates a pressure map that allows image registration. Under same applied pressure, the pressure map should stay constant in spite of changes in other sensor readings.

In another aspect, an image registration system includes an imaging device configured to obtain first and second images of a surface (e.g. SEM data of a skin surface, or the like). The system further includes a sensor (such as a pressure sensor, bend sensor, or the like) configured to obtain secondary data relating to the first and second images. A processor and programming executable on the processor is included for carrying out the steps of: calculating a transform model as a function of both the first and second images and said secondary data relating to said first and second images; and generating an image registration between the first and second images as a function of said transform model.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is an overview of a prior art image registration method.

FIG. 2 illustrates an exemplary wound image registration method in accordance with the present invention.

FIG. 3 illustrates a system for performing wound image registration in accordance with the present invention.

FIG. 4 illustrates pressure and moisture measurements obtained according to an embodiment of the invention.

FIG. 5 illustrates sample measurements over two different days.

FIG. 6 illustrates measurement of the angle (curve) of a wound patch on the skin according to an embodiment of the invention.

FIG. 7 is an overview of the wound registration method according to an embodiment of the invention

FIG. 8 illustrates information from bend sensors in a first measurement according to an embodiment of the invention.

FIG. 9 shows the results of a surface fit to produce a surface that holds the curve in FIG. 8.

FIG. 10 illustrates information from bend sensors in a second measurement according to an embodiment of the invention.

FIG. 11 shows the results of a surface fit to produce a surface that holds the curve in FIG. 10.

FIGS. 12A and 12B illustrate determining a transformation function between the surfaces of FIG. 9 and FIG. 11 respectively and using the transformation function in the registration process of moisture data according to an embodiment of the invention.

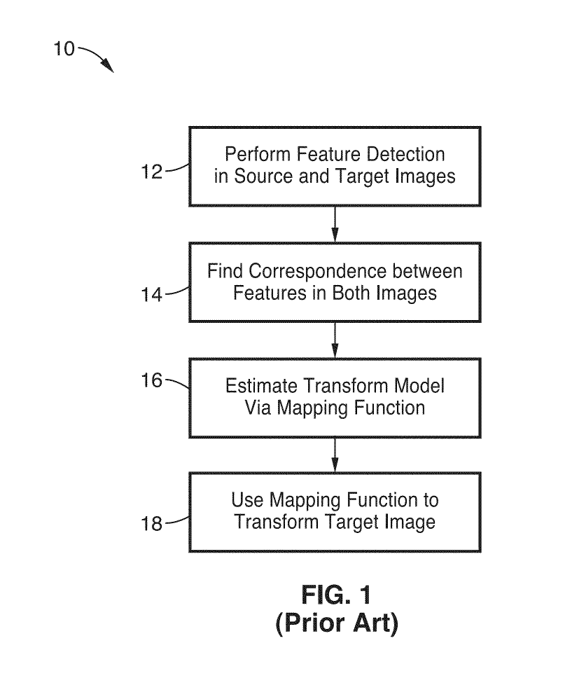

### DETAILED DESCRIPTION OF THE INVENTION

In the context of studying different parameters such as moisture among a population, the image registration systems and methods of the present invention may be configured to enable mapping of wound image scans to each other for comparison and study. This is possible since general body shape and bony prominents are similar among people in a population. Using this method, readings from different people can be mapped for investigating various parameters.

It will be appreciated, however, that the present invention can be used not only for wound image registration, but for registration of any images.

Wound image registration enables mapping of wound image scans to each other for comparison and study, due to the variations in the image capture. The goal of registration is to establish the correspondence between two images and determine an optimal transformation between two images. The two images (source and target) are either from the same scene acquired at different times or from different view points.

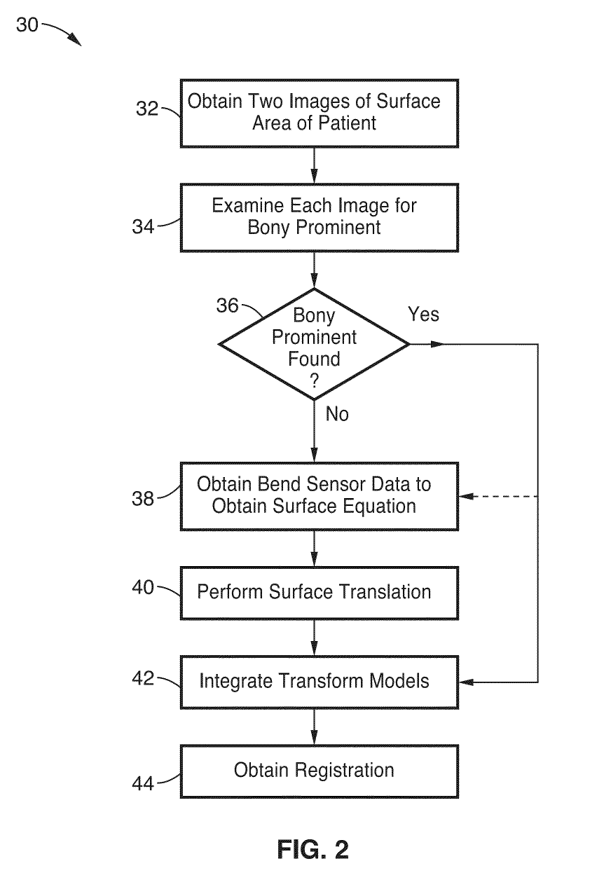

FIG. 2 illustrates an exemplary pressure image registration method 30 of the present invention. Method 30 optionally uses body characteristics, such as bony prominents, curvature of body parts to find the transformation function in accordance with the present invention. The transformation function is applied to desired sensor readings to obtain correct mapping. In addition to pressure readings, other sensor data such as bend sensors can be used to obtain more information about the transformation function. As an example, bend sensors can be used to measure curvature of body parts.

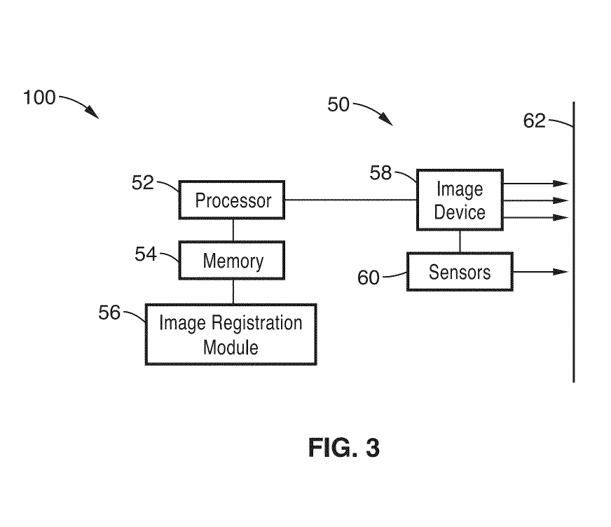

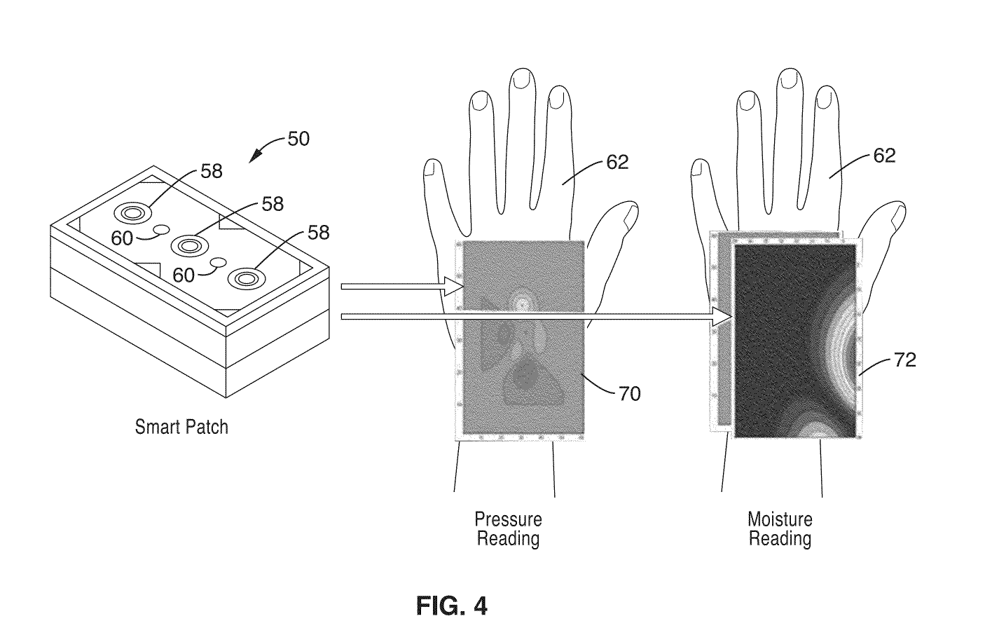

In first step shown at block 32, wound images are obtained. These images are preferably obtained from a smart patch 50, or similar device, shown in FIGS. 3 and 4, which is able to retrieve multiple types of images from the same wound scan, e.g. a moisture map 72 and a pressure map 70 of a target region such as a bony prominence.

As seen in FIG. 3, image registration system generally comprises a smart patch or similar device 50 that comprises an imaging device 58 and one or more sensors 60, both configured to take readings of target 62 (e.g. the patients skin). However, it is appreciated that any imaging device that is capable of measuring or receiving secondary input, (e.g. pressure, strain, orientation etc.) from the primary imaging data, may be used.

The system 100 generally includes a processor 52 configured to receive data from smart patch 50 and process it according to the image registration module 56 of the present invention. Image registration module 56 comprises software, algorithms, or the like to carry out the methods presented herein, and is generally stored in memory 54 along with other operational modules and data.

FIG. 4 demonstrates a sensor/imaging patch 50 applied to a target region of skin 62 to obtain pressure and moisture measurements. The sensor/imaging patch 50 may comprise one or more imaging devices 58, along with one or more secondary input sensor 60. In a preferred embodiment, the imaging devices 58 may comprise RF electrodes to obtain Sub-Epidermal Moisture (SEM) readings or map 72, while the sensors 60 comprise one or more pressure sensors to obtain a pressure reading or map 70.

The sensor/imaging patch 50 enables the registration of two different readings, obtained on two different days, as shown in FIG. 5. The left column shows the reading, including pressure map 70 and moisture map 72 from a first date (e.g. day 1). The right column shows pressure map 74 and moisture map 76 readings from a second date (e.g. day 2). Note the images obtained may be severely misaligned (as shown in FIG. 5 depicting 90 degree misalignment of angular orientation).

Pressure image registration as that provided in system 100 enables mapping of sensor readings to each other for comparison and study, due to the variations in the image captured. The capture of pressure information in addition to desired sensor data (e.g. moisture image data 72) creates a pressure map 72 that allows image registration. Under same applied pressure, the pressure map should stay constant in spite of changes in other sensor readings.

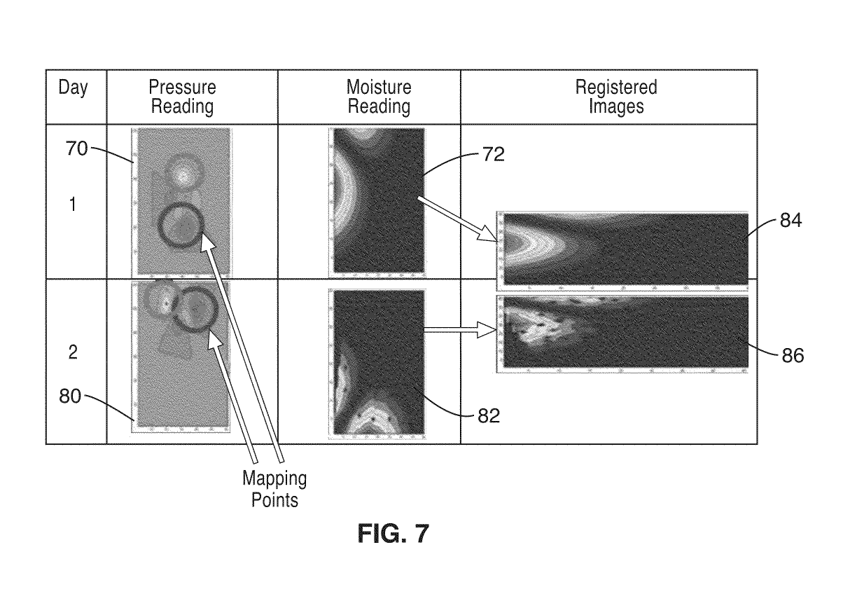

Referring to FIG. 7, the image registration module uses mapping points from the pressure reading 70 from day 1 along with the moisture reading 72 from the first day to generate a registered image 84. Based on the transfer function found from pressure readings 70 and 80, the moisture reading 72 and 82 are registered to 84 and 86 respectively. The registered image 84 may then be compared with the registered image 86 from a second date that is obtained from pressure reading 80 and moisture reading 82 from that date.

One notable difference between the image registration system 100 and method 30 of the present invention and previous work is that the two images can be significantly different from each other, due to the changes in wound healing. Additionally, pressure readings obtained from the device 50 aid the improved registration of the more pertinent moisture maps. Bony prominence can be used in the feature detection phase described below.

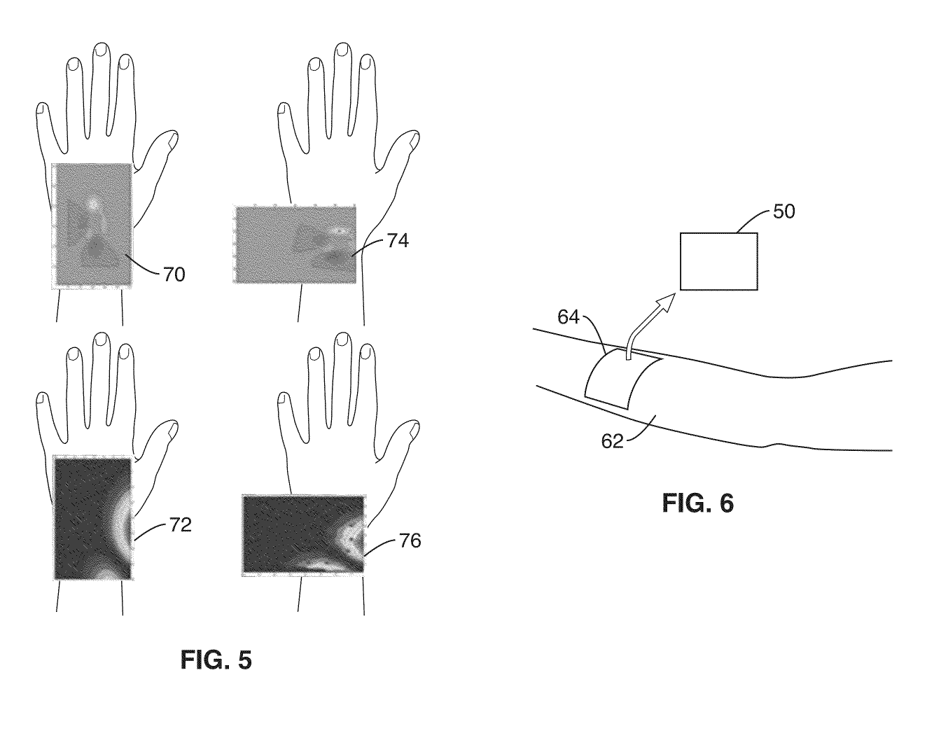

Referring to now FIG. 6, to perform registration between two different wound images in situations where bony prominent are not available (e.g. the curved surface 64 of patient's skin 62) data pertaining to the shape of the deformable patch 50 on the body may be incorporated. In such configuration, sensors 60 may comprise bend/flex sensors in alternative to or in addition to pressure sensors to evaluate the positioning of the patch 50 on the body 62.

Referring to FIG. 4, bend sensors 60 may embedded on the surface of the patch 50, and can measure the angle of the patch on the curved section 64 of skin as shown in FIG. 6. Multiple bend sensors 60 may be used in one surface. Each bend sensor can cover a patch in the surface and be used in order to derive a more accurate equation of the surface. The bend/flex sensors 60 change in resistance as the bend angle changes, such that the output of the flex sensor 60 is a measure of the bend or angle of the pad applied to the skin.

Referring back to the method 30 shown in FIG. 3, information from bend sensor 62 may be either be integrated with the results from image registration using bony prominent as control points, or can be used as a standalone method to perform registration. In other words, the surface equation may be used as another feature in the registration process.

From the images obtained in step 32, each image is examined for a bony prominent at step 34. At step 36, if a bony prominent are found, steps 38 and 40 are optional.

If no bony prominent is found for a control point, data is acquired from the bend sensors 60 to model the surface of the patch and find a surface equation of both surfaces at step 38.

A surface translation is then performed at step 40 to find the transform model.

In the case of two transform models (e.g. pressure map and surface position), both are integrated to obtain one transform model at step 42. As explained above, even if the bony prominent is found, the bony prominent may be used as control points for calculation with bend sensor data from steps 38 and 40. The integration step 42 is therefore only required if bony prominent control points are used in combination with bend sensor data, and thus integration of the two datasets is needed to obtain one transfer model.

At step 40, the obtained the transform model is then used to perform image registration.

Experimental Data

Two measurements were obtained from locations without any bony prominent, therefore pressure map information was not used to perform registration. In this case, information from bend sensors was used to model a surface equation in both measurements:

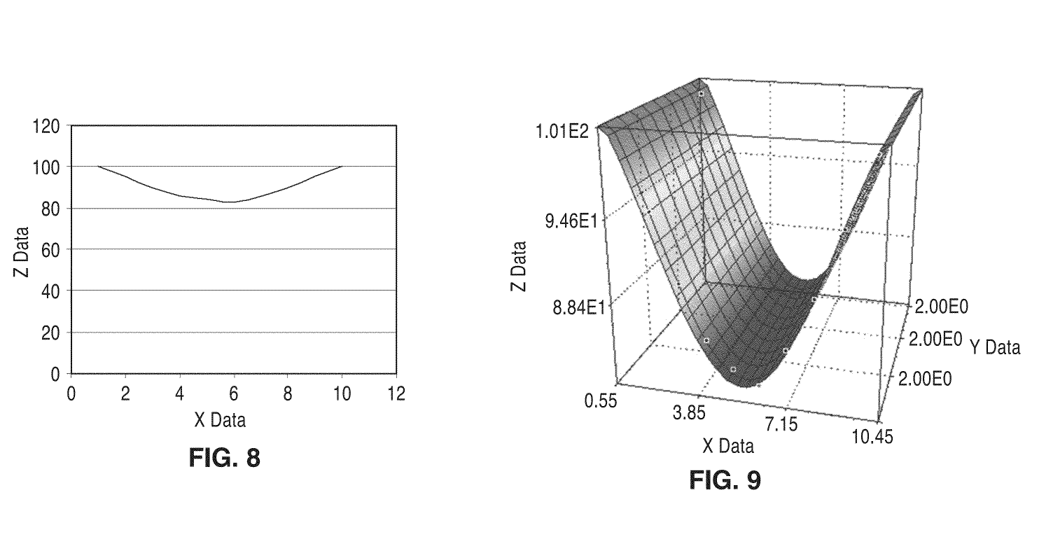

Information from bend sensors in the first measurement are plotted in the curve shown in FIG. 8. Surface fitting was performed to obtain the surface that holds this curve. The following equation represents this surface with a sum of absolute errors of 5.571006E-01:

z=a+bx⁰y¹+cx¹y⁰+dx¹y¹+ex²y⁰+fx²y¹+gx³y⁰+hx³y¹+ix⁴y⁰+jx⁴y¹

where:

a=2.0566666666661781E+01

b=4.1133333333329858E+01

c=−2.5291375289503831E−01

d=−5.0582750578638869E−01

e=−3.9761072261844288E−01

f=−7.9522144523689464E−01

g=7.6107226108293152E−02

h=1.5221445221658630E−01

i=−3.4382284382742257E−03

j=−6.8764568765484514E−03

This surface is shown in FIG. 9.

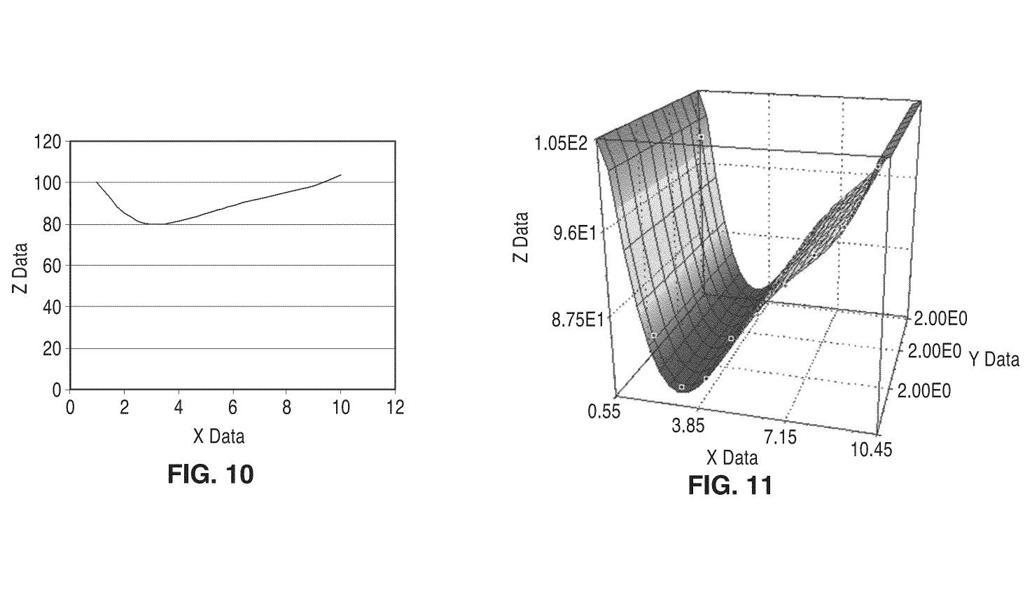

Information from bend sensors in the second measurement, results in a curve shown in FIG. 10. Similarly, the surface equation is obtained using surface fitting. The result is a surface with a sum of absolute errors of 1.29156205E+00 according to the following equation:

z=a+bx⁰y¹+cx¹y⁰+dx¹y¹+ex²y⁰+fx²y¹+gx³y⁰+hx³y¹+ix⁴y⁰+jx⁴y¹

where:

a=2.6168333333318493E+01

b=5.2336666666666723E+01

c=−8.1697241646990388E+00

d=−1.6339448329396959E+01

e=2.2407721445123507E+00

f=4.4815442890247104E+00

g=−2.4108585858450268E−01

h=−4.8217171716900536E−01

i=9.3269230768639362E−03

j=1.8653846153727872E−02

This surface is shown in FIG. 11.

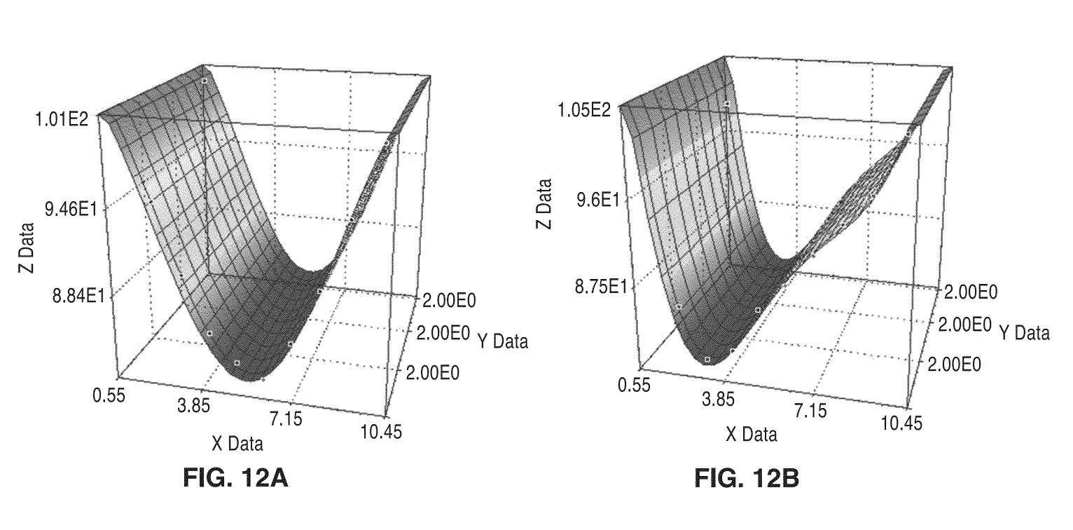

Having the surfaces for each measurement, the transformation function is found between these two surfaces as T and use T as the transformation function in the registration process of the moisture data as shown in FIG. 12A and FIG. 12B.

In a preferred embodiment, the method 30 of FIG. 3 is incorporated into a wound management system that analyzes the data obtained from a continuous monitoring device. The data would be passed through the registration system before the data comparison and analysis is performed.

The system and methods of the present invention may be incorporated into any system where pressure data or curvature data is aggregated together with other desired readings.

The system and methods of the present invention may be used in field for proper wound scanner alignment, and allow greater accuracy in wound management and analysis.

The system and methods of the present invention also allow for standardization of wound management images, which is important for analysis and inference of the data obtained from wound management and monitoring systems. Additionally, the system and methods of the present invention enable the use of smart patch systems for continuous monitoring and comparison of conditions.

From the foregoing, it will be appreciated that the present invention may be described with reference to steps carried out according to methods and systems according to embodiments of the invention. These methods and systems can be implemented as computer program products. In this regard, each step or combinations of steps can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the describes steps.

Accordingly, the invention encompasses means for performing the specified functions, combinations of steps for performing the specified functions, and computer program instructions, such as embodied in computer-readable program code logic means, for performing the specified functions. It will also be understood the functions can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the specified functions.

From the foregoing, it will be appreciated that the present invention can be embodied in various ways, which include but are not limited to the following:

1. An image registration system, comprising: an imaging device configured to obtain first and second images of a surface; a sensor configured to obtain secondary data relating to said first and second images; a processor; and programming executable on said processor for: calculating a transform model as a function of both the first and second images and said secondary data relating to said first and second images; and generating an image registration between the first and second images as a function of said transform model.

2. The image registration system of embodiment 1: wherein the surface comprises a patient's skin; and wherein the first and second images comprise Sub-Epidermal Moisture (SEM) data.

3. The image registration system of embodiment 2: wherein the sensor comprises a pressure sensor; and wherein the secondary data comprises pressure data relating to application of the imaging device.

4. The image registration system of embodiment 2: wherein the sensor comprises a bend sensor; and wherein the secondary data comprises bend data relating to application of the imaging device over a curved surface.

5. The image registration system of embodiment 3: wherein the sensor further comprises a bend sensor; and wherein the secondary data further comprises bend data relating to application of the imaging device over a curved surface.

6. The image registration system of embodiment 5, wherein said programming is further configured for: examining each image for a bony prominent beneath said skin surface; modeling surface features based on said bony prominent to obtain a surface equation for surfaces imaged in the first and second image; and performing a surface translation as a function of said equation to calculate said transform model for a surface in the first and second images.

7. The image registration system of embodiment 6, wherein said programming is further configured for: integrating first and second transform models to obtains said transform model.

8. The image registration system of embodiment 5, wherein said programming is further configured for: examining each image for a bony prominent beneath said skin surface; and if a bony prominent is found integrating first and second transform models to obtain said transform model.

9. The image registration system of embodiment 8, wherein if a bony prominence is not found, said programming is further configured for: modeling surface features based on said bony prominent to obtain a surface equation for surfaces imaged in the first and second image; and performing a surface translation as a function of said equation to calculate said transform model for a surface in the first and second images prior to integrating first and second transform models.

10. An image registration system, comprising: a processor; and programming executable on said processor for: acquiring first and second images of a surface from an imaging device; acquiring secondary data relating to said first and second images from a sensor; calculating a transform model as a function of both the first and second images and said secondary data relating to said first and second images; and generating an image registration between the first and second images as a function of said transform model.

11. The image registration system of embodiment 10: wherein the surface comprises a patient's skin; and wherein the first and second images comprise Sub-Epidermal Moisture (SEM) data.

12. The image registration system of embodiment 11: wherein the sensor comprises a pressure sensor; and wherein the secondary data comprises pressure data relating to application of the imaging device.

13. The image registration system of embodiment 11: wherein the sensor comprises a bend sensor; and wherein the secondary data comprises bend data relating to application of the imaging device over a curved surface.

14. The image registration system of embodiment 13: wherein the sensor further comprises a bend sensor; and wherein the secondary data further comprises bend data relating to application of the imaging device over a curved surface.

15. The image registration system of embodiment 14, wherein said programming is further configured for: examining each image for a bony prominent beneath said skin surface; modeling surface features based on said bony prominent to obtain a surface equation for surfaces imaged in the first and second image; and performing a surface translation as a function of said equation to calculate said transform model for a surface in the first and second images.

16. The image registration system of embodiment 15, wherein said programming is further configured for: integrating first and second transform models to obtain said transform model.

17. The image registration system of embodiment 14, wherein said programming is further configured for: examining each image for a bony prominent beneath said skin surface; and if a bony prominent is found integrating first and second transform models to obtains said transform model.

18. The image registration system of embodiment 17, wherein if a bony prominence is not found, said programming is further configured for: modeling surface features based on said bony prominent to obtain a surface equation for surfaces imaged in the first and second image; and performing a surface translation as a function of said equation to calculate said transform model for a surface in the first and second images prior to integrating first and second transform models.

19. An image registration method, comprising: acquiring first and second images of a surface using an imaging device; acquiring secondary data relating to said first and second images using a sensor; calculating a transform model as a function of both the first and second images and said secondary data relating to said first and second images; and generating an image registration between the first and second images as a function of said transform model.

20. The image registration method of embodiment 19: wherein the surface comprises a patient's skin; and wherein the first and second images comprise Sub-Epidermal Moisture (SEM) data.

21. The image registration method of embodiment 20: wherein the sensor comprises a pressure sensor; and wherein the secondary data comprises pressure data relating to application of the imaging device.

22. The image registration method of embodiment 20: wherein the sensor comprises a bend sensor; and wherein the secondary data comprises bend data relating to application of the imaging device over a curved surface.

23. The image registration method of embodiment 22: wherein the sensor further comprises a bend sensor; and wherein the secondary data further comprises bend data relating to application of the imaging device over a curved surface.

24. The image registration method of embodiment 23, further comprising: examining each image for a bony prominent beneath said skin surface; modeling surface features based on said bony prominent to obtain a surface equation for surfaces imaged in the first and second image; and performing a surface translation as a function of said equation to calculate said transform model for a surface in the first and second images.

25. The image registration method of embodiment 25, further comprising: examining each image for a bony prominent beneath said skin surface; and if a bony prominent is found integrating first and second transform models to obtain said transform model.

26. The image registration method of embodiment 25, wherein if a bony prominence is not found, further comprising: modeling surface features based on said bony prominent to obtain a surface equation for surfaces imaged in the first and second image; and performing a surface translation as a function of said equation to calculate said transform model for a surface in the first and second images prior to integrating first and second transform models.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An image registration system, comprising:
an imaging device configured to obtain first and second images of a surface;
a sensor configured to obtain secondary data relating to said first and second images;
a processor; and
programming executable on said processor for:
calculating a transform model as a function of both the first and second images and said secondary data relating to said first and second images; and
generating an image registration between the first and second images as a function of said transform model.

2. An image registration system as recited in claim 1:
wherein the surface comprises a patient's skin; and
wherein the first and second images comprise Sub-Epidermal Moisture (SEM) data.

3. An image registration system as recited in claim 2:
wherein the sensor comprises a pressure sensor; and
wherein the secondary data comprises pressure data relating to application of the imaging device.

4. An image registration system as recited in claim 2:
wherein the sensor comprises a bend sensor; and
wherein the secondary data comprises bend data relating to application of the imaging device over a curved surface.

5. An image registration system as recited in claim 3:
wherein the sensor further comprises a bend sensor; and
wherein the secondary data further comprises bend data relating to application of the imaging device over a curved surface.

6. An image registration system as recited in claim 5, wherein said programming is further configured for:
examining each image for a bony prominent beneath said skin surface;
modeling surface features based on said bony prominent to obtain a surface equation for surfaces imaged in the first and second image; and
performing a surface translation as a function of said equation to calculate said transform model for a surface in the first and second images.

7. An image registration system as recited in claim 6, wherein said programming is further configured for:
integrating first and second transform models to obtains said transform model.

8. An image registration system as recited in claim 5, wherein said programming is further configured for:
examining each image for a bony prominent beneath said skin surface; and
if a bony prominent is found integrating first and second transform models to obtain said transform model.

9. An image registration system as recited in claim 8, wherein if a bony prominence is not found, said programming is further configured for:
modeling surface features based on said bony prominent to obtain a surface equation for surfaces imaged in the first and second image; and
performing a surface translation as a function of said equation to calculate said transform model for a surface in the first and second images prior to integrating first and second transform models.

10. An image registration system, comprising:
a processor; and
programming executable on said processor for:
acquiring first and second images of a surface from an imaging device;
acquiring secondary data relating to said first and second images from a sensor;
calculating a transform model as a function of both the first and second images and said secondary data relating to said first and second images; and
generating an image registration between the first and second images as a function of said transform model.

11. An image registration system as recited in claim 10:
wherein the surface comprises a patient's skin; and
wherein the first and second images comprise Sub-Epidermal Moisture (SEM) data.

12. An image registration system as recited in claim 11:
wherein the sensor comprises a pressure sensor; and
wherein the secondary data comprises pressure data relating to application of the imaging device.

13. An image registration system as recited in claim 11:
wherein the sensor comprises a bend sensor; and
wherein the secondary data comprises bend data relating to application of the imaging device over a curved surface.

14. An image registration system as recited in claim 13:
wherein the sensor further comprises a bend sensor; and
wherein the secondary data further comprises bend data relating to application of the imaging device over a curved surface.

15. An image registration system as recited in claim 14, wherein said programming is further configured for:
examining each image for a bony prominent beneath said skin surface;
modeling surface features based on said bony prominent to obtain a surface equation for surfaces imaged in the first and second image; and
performing a surface translation as a function of said equation to calculate said transform model for a surface in the first and second images.

16. An image registration system as recited in claim 15, wherein said programming is further configured for:
integrating first and second transform models to obtain said transform model.

17. An image registration system as recited in claim 14, wherein said programming is further configured for:
examining each image for a bony prominent beneath said skin surface; and
if a bony prominent is found integrating first and second transform models to obtains said transform model.

18. An image registration system as recited in claim 17, wherein if a bony prominence is not found, said programming is further configured for:
modeling surface features based on said bony prominent to obtain a surface equation for surfaces imaged in the first and second image; and
performing a surface translation as a function of said equation to calculate said transform model for a surface in the first and second images prior to integrating first and second transform models.

19. An image registration method, comprising:
acquiring first and second images of a surface using an imaging device;
acquiring secondary data relating to said first and second images using a sensor;
calculating a transform model as a function of both the first and second images and said secondary data relating to said first and second images; and
generating an image registration between the first and second images as a function of said transform model.

20. An image registration method as recited in claim 19:
wherein the surface comprises a patient's skin; and
wherein the first and second images comprise Sub-Epidermal Moisture (SEM) data.

21. An image registration method as recited in claim 20:
wherein the sensor comprises a pressure sensor; and
wherein the secondary data comprises pressure data relating to application of the imaging device.

22. An image registration method as recited in claim 20:
wherein the sensor comprises a bend sensor; and
wherein the secondary data comprises bend data relating to application of the imaging device over a curved surface.

23. An image registration method as recited in claim 22:
wherein the sensor further comprises a bend sensor; and
wherein the secondary data further comprises bend data relating to application of the imaging device over a curved surface.

24. An image registration method as recited in claim 23, further comprising:
examining each image for a bony prominent beneath said skin surface;
modeling surface features based on said bony prominent to obtain a surface equation for surfaces imaged in the first and second image; and
performing a surface translation as a function of said equation to calculate said transform model for a surface in the first and second images.

25. An image registration method as recited in claim 24, further comprising:
if a bony prominent is found, integrating first and second transform models to obtain said transform model.

26. An image registration method as recited in claim 25, wherein if a bony prominence is not found, further comprising:
modeling surface features based on said bony prominent to obtain a surface equation for surfaces imaged in the first and second image; and
performing a surface translation as a function of said equation to calculate said transform model for a surface in the first and second images prior to integrating first and second transform models.
